(19) United States
(12) Patent Application Publication
(10) Pub. No.: US 2010/0029210 A1
(43) Pub. Date: Feb. 4, 2010

(54) Method, apparatus and computer program for estimating spectrum using a folding ADC

(75) Inventors: Mikko Kaltiokallio, Espoo (FI); Saska Lindfors, Espoo (FI); Jussi Ryynanen, Vantaa (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/148,859

(22) Filed: Apr. 22, 2008

(51) Int. Cl. H04B 17/00; G05B 23/00

(52) U.S. Cl. 455/62; 340/5.1

(57) ABSTRACT

To find frequency slots over which a cognitive radio can send an opportunistic transmission, a wideband spectrum is searched with a lower resolution to identify bandwidth slices having low or no signal levels. The identified bandwidth slices are searched with a higher resolution candidate frequency slices are selected as those bandwidth slices having least signal levels after the higher resolution searching, and ranked from lowest signal level to highest. A spectrum detection algorithm is executed on the selected candidate frequency slices in the order of the rank until it is decided that one of them has sufficiently free spectrum. A transmission is then opportunistically sent on the decided candidate frequency slice. Ongoing to the searching, intermittent signals are detected and a band about them is searched with the lower resolution to determine if the band about the detected intermittent signal is an identified bandwidth slice. Various techniques are shown for how the fine search is conducted.

### TECHNICAL FIELD

The teachings herein relate generally to cognitive radio networks and sensing spectrum therein that a cognitive radio device may then use opportunistically as it is available and not in use by primary users operating with allocated resources. These teachings are particularly related to employing an analog to digital converter in such cognitive spectrum sensing.

### BACKGROUND

Spectrum sensing is needed in cognitive radios to find empty slots in the radio spectrum which can subsequently be used in an opportunistic manner. Traditionally radio spectrum is divided between different radio systems in a manner that strictly allocates a specific band to a specific system. This strict allocation will be changing to a more flexible spectrum utilization at least in some frequency bands in the future. Primary users are those operating within the more formal networks such as hierarchical networks (e.g., WLAN or cellular such as GSM, GERAN, UTRAN and E-UTRAN) and ad hoc networks (e.g., WiFi). Secondary users are those operating outside the structure of the formal networks. Since essentially all spectrum in crowded areas that is useable by mobile terminals is allocated to some formal network or another, the secondary users find and utilize portions of the existing networks' spectrum in an opportunistic manner. Consequently, two related obstacles face the secondary user: it must not interfere with the primary users, and it must somehow find those portions of the spectrum not currently in use by any of the formal networks. For this latter reason the secondary users are generally referred to as cognitive users; they must be spectrum-aware rather than simply using the radio resources allocated by some access node controlling a cell of users.

The secondary user/cognitive radio therefore utilizes or exploits a free region of spectrum for its own transmissions, outside control of the formal networks. By “free” what is meant is that the primary users/formal networks are not using the spectrum region in question when considering time, frequency and space. Thus, radios that contend for radio resources within a pre-ordained contention period are not considered cognitive radios. Alternatively there could be a band that is dedicated to several radio systems operating under a certain set of rules or policies. The common factor in any case is that the radio spectrum will have to be sensed somehow in order for the cognitive radio/secondary user to locate the free spectral band. This sensing has to at least take into account time, frequency and space.

The cognitive radio may or may not also be in communication with a more traditional cellular or other type network, but the cognitive function is independent. Spectrum sensing may be done by each radio for the entire spectral band to be sent or it may be partitioned in some way among the various cognitive radios. The former is power intensive for radios having a portable power supply, and the latter implies a non-negligible signaling overhead to inform the sister cognitive radios of each other's sensing result, particularly challenging when the spectrum is only available opportunistically.

The cognitive radio system is best served when the spectrum analyzed for these opportunistic frequency ‘holes’ is wideband, giving a higher likelihood of finding a sufficient number of holes not occupied by the primary users to carry on an ongoing communication. However, the continuous-time wideband frequency analysis combined with high accuracy is extremely difficult since it would require high speed and high resolution analog-to-digital converters ADCs.

One way to increase accuracy is to analyze only narrow bands. However, in order to cover wide-bands this method is slow and does not necessarily capture time-variant changes. As a solution to this problem there have been spectrum evaluation schemes that can be broadly categorized as two types. One type analyzes spectrum in narrowband, capable of detecting very weak as well as large signals within this narrow band. The other type evaluates wideband spectrum with limited accuracy, and while the band evaluated is much wider than the narrowband type it can only detect signals which have powers above a specific threshold level. The wideband approach requires implementation of a high speed ADC which increases power consumption of the ADC itself and in addition it increases the speed requirements and power consumption of the following digital circuitry. Generally, very wideband spectrum analysis requires significant power consumption even with moderate accuracies, making the implementation of this type of sensing very challenging.

Being a very forward-looking technology at this stage of development, there is not a great volume of prior art in the spectrum sensing field. Two are noted below as potentially relevant to these teachings.

EP0582037 is entitled Method and Apparatus for Improving Wideband Detection of a Tone. It describes that an in-phase signal is sampled at an input of a first analog-to-digital converter (41), and a quadrature signal is sampled at an input of a second analog-to-digital converter (42). The output of the first analog-to-digital converter (41) is delayed by an amount equal to one, plus an integer number times four, sample periods to provide a delayed in-phase signal. Then the delayed in-phase signal is added to the quadrature signal to provide a sum signal. Then a tone is detected in the sum signal. In one embodiment, a data processor (32) stores the output of the analog-to-digital converters (41, 42) in memory (34) and processes the data as programmed by microcode (33).

WO2007/056673 is entitled Wide-Bandwidth Spectrum Analysis of Transient Signals Using a Real-Time Spectrum Analyzer. This paper describes its teachings as selecting a frequency window for a real time analyzer RTSA acquisition, the frequency window being narrower in bandwidth than the frequency spectrum of interest. An RTSA is tuned to a plurality of different frequencies within the frequency spectrum of interest, where such successive tuning is controlled based on a characteristic of the signal. The RF signal is received, and for each of the plurality of different frequencies, power data is acquired for the signal in a band centered on the frequency and having a bandwidth equal to that of the frequency window. A representation of the frequency spectrum of interest is then constructed from the power data acquired during the successive tunings of the RTSA

But as noted above, wideband spectrum sensing for the cognitive radio purpose is highly power-intensive, and the vast majority of cognitive radios are anticipated to be portable wireless devices. What is needed in the art is a way to find those free areas that may be located anywhere among the wideband spectrum at various times with low power requirements and high confidence level.

### SUMMARY

In accordance with one embodiment of the invention there is a method that includes downconverting a first analog signal, sampling the downconverted first analog signal using a first set of analog-to-digital converter sampling parameters, and storing a resulting first set of samples. The method continues in downconverting a second analog signal, sampling the downconverted second analog signal using a second set of analog-to-digital converter sampling parameters, and storing a resulting second set of samples. Then are determined samples that are common to the first set of samples and the second set of samples, and the determined samples are output.

In accordance with another embodiment of the invention there is an apparatus that includes a local oscillator, and analog-to-digital processor, a memory and a processor. The local oscillator is configured to downconvert a first analog signal and a second analog signal. The analog to digital converter is configured to sample the downconverted first analog signal using a first set of analog-to-digital converter sampling parameters, and to sample the downconverted second analog signal using a second set of analog-to-digital converter sampling parameters. The memory is configured to store a first set of samples from the analog to digital converter sampling of the first analog signal and to store a second set of samples from the analog to digital converter sampling of the second analog signal. And the processor is configured to determine samples that are common to the stored first set of samples and the stored second set of samples and to output the determined samples that are common.

In accordance with another embodiment of the invention there is a computer readable memory embodying a program of machine-readable instructions executable by a digital data processor to perform actions directed toward Sampling analog signals. In this embodiment the actions include downconverting a first analog signal, sampling the downconverted first analog signal using a first set of analog-to-digital converter sampling parameters, and storing a resulting first set of samples, downconverting a second analog signal, sampling the downconverted second analog signal using a second set of analog-to-digital converter sampling parameters, and storing a resulting second set of samples, determining samples that are common to the first set of samples and the second set of samples, and outputting the determined samples.

In accordance with another embodiment of the invention there is an apparatus that includes conversion means (such as for example an analog to digital converter), storage means (such as for example a computer readable memory), and decision means (such as for example a processor, ASIC or FPGA). The conversion means is for sampling a first analog signal at a first frequency and for sampling a second analog signal at a second frequency. The storage means is for storing a first set of samples from the conversion means' sampling of the first analog signal and for storing a second set of samples from the conversion means' sampling of the second analog signal. And the decision means is for deciding samples that are common to the stored first set of samples and the stored second set of samples and for causing the determined samples that are common to be output for signal processing.

These and other aspects of the invention are detailed more particularly below.

### BRIEF DESCRIPTION OF THE DRAWINGS

The foregoing and other aspects of these teachings are made more evident in the following Detailed Description when read in conjunction with the attached Drawing Figures.

FIG. 1A illustrates two pairs of terminals communicating as cognitive radio pairs, and

FIG. 1B shows two cognitive terminals communicating without an access node with high-level details of one of the terminals shown schematically.

FIG. 2 is a sample mapping diagram illustrating the concept of ADC folding.

FIG. 3 is a sample mapping diagram illustrating even and odd sections of the spectrum with local oscillator shifting.

FIG. 4 is similar to FIG. 3 but showing the sections with sampling frequency shifting.

FIG. 5 shows two sample mapping diagrams and finding common samples using the local oscillator shifting of FIG. 3.

FIG. 6 is similar to FIG. 5 but showing the sampling frequency shifting of FIG. 4.

FIG. 7 is similar to FIG. 6 and showing formation of non-existent frequencies in the detection.

FIGS. 8A-8B is a sample mapping diagram illustrating a bandwidth problem and a solution to that problem by setting the shift in sampling frequency higher than the highest signal bandwidth present.

FIG. 9 is a schematic block diagram showing further detail over FIG. 1B.

FIG. 10 is a process flow diagram detailing process steps according to an embodiment of the invention.

### DETAILED DESCRIPTION

The inventors' solution to the problem formulated above involves using the folding phenomena of the ADCs for spectrum analysis, which will be shown to reduce significantly the overall power consumption of the spectrum receiver. Detailed further below is how to define the “original” frequencies from the folded spectrum. Specifically, some of the below teachings can be parsed into the following categories:

Use of folding phenomena of the ADC for spectrum estimation.

Use of combinational method for discovering original frequencies in the spectrum estimation.

Use of local oscillator LO shifting for discovering original frequencies in the spectrum estimation.

Use of sampling frequency alteration for discovering original frequencies in the spectrum estimation.

Consider a broad example: the cognitive radio receiver is doing some kind of narrowband spectrum analysis. However, it needs information of the spectrum from some wider band that is analyzed with some narrowband method. This information may be needed, for example, to detect changes in the environment that may affect the narrowband analysis. Mainly the information on large signals, which are passed to receiver input are interesting for the analyzer. Thus some wideband spectrum analyzer is needed. These teachings improve power consumption in that wideband sensing as compared to the prior art.

The spectrum is analyzed using functions found on a typical spectrum analyzer. Extending this to the mobile environment, the spectrum analysis may be done using a wideband high speed ADC with moderate accuracy, or using a lower speed and high accuracy ADC for the narrower bands. If large spectrums would be analyzed in details with high accuracy, going through the entire wideband spectrum would require time, which as above undermines the whole spectrum sensing process when primary users and the holes they leave shift regularly, as it's the case in crowded radio use areas.

The folding aspect of ADCs is known in the art. However, to the invertors' knowledge it has not been used in spectrum evaluation such as that required for example in cognitive radios. In addition, methods how to analyze what are termed below as the “original” frequencies from a folded spectrum have not been explored in the prior art, to inventors' knowledge. These are detailed below.

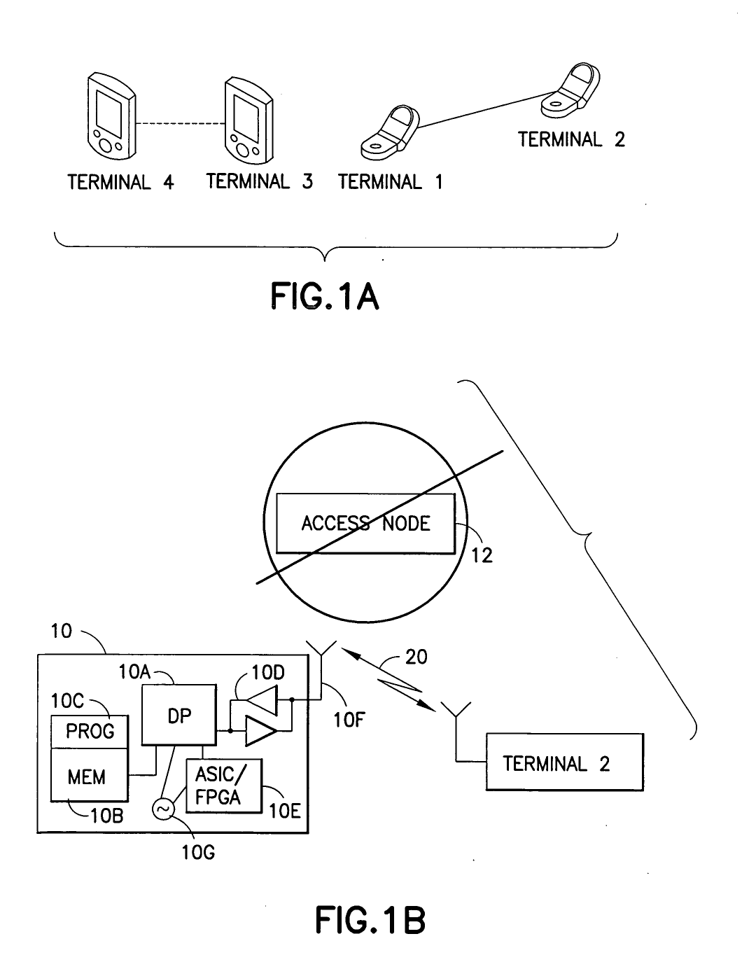

But prior to describing the various embodiments and aspects of the invention in detail, some general information as to the cognitive radio and its environment are presented at FIGS. 1A-1B. FIG. 1A shows two pairs of cognitive radios each forming their own cognitive network. Note that there is no access node involved; terminals 1 and 2 communicate directly with one another opportunistically using the free spectrum they found, and terminals 3 and 4 do the same using the free spectrum that they have found. Each one of the pairs of cognitive radios are of the same rank in their own network; there is no master-slave relation as in Bluetooth for example, though it may be that the cognitive radios each reference a common timing signal to stay synchronized. Additionally, each one of the cognitive radios in both of the cognitive networks are all of the same rank, so all are in competition for the same free spectrum. Each of the four cognitive radios are responsible for using that free spectrum in a manner that does not interfere with primary users who may be operating in the same geographic area, a principle that gives rise to the spectrum sensing task itself.

FIG. 1B shows a high level block diagram of one of the cognitive terminals 10 of FIG. 1A which is in communication with another cognitive terminal, terminal 2. Also shown in a network access node 12, blocked out to make clear that these diagrams refer to cognitive radios operating on an opportunistic basis and not according to an ad-hoc or hierarchical network protocol. It is noted that the cognitive radio 10 may still be in communication with the access node 12, but separately from its spectrum sensing and cognitive network communications. The cognitive radio terminal 10 includes a data processor (DP) 10A, a memory (MEM) 10B that stores a program (PROG) 10C, and a suitable radio frequency (RF) transceiver 10D coupled to one or more antennas 10F (one shown) for bidirectional wireless communications over one or more wireless links 20 with the other cognitive user terminal 2. The cognitive radio 10 may also include, as embodiments of the invention, an application specific integrated circuit ASIC and/or field programmable gated array FPGA 10E coupled to or as a part of the DP 10A. A local oscillator 10G provides timing information as will be detailed below for sampling, and is shown separate in FIG. 1B but may be within the DP 10A or ASIC/FPGA 10E in certain embodiments.

The ADC and filters detailed below may reside within the receiver portion of the transceiver 10D, within an ASIC 10E such as a RF front end that lies in the position of the transceiver 10D of FIG. 1B, within the DP 10A, or separately and between the depicted transceiver 10D and DP 10A. Each of these are implementation details. It is understood that terminal 2 may also have similar hardware as is shown for the terminal 10, though it is not necessary for operation of the detailed terminal 10 that terminal 2 sense spectrum used for the link 20 in the same manner.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

The PROG 10C is assumed to include program instructions that, when executed by the DP 10A, enable the cognitive radio terminal 10 to operate in accordance with the exemplary embodiments of this invention, as detailed above. Inherent in the DP 10A is a local clock to enable synchronism among the various terminals, which is important in some cognitive radio architectures. The PROG 10C may be embodied in software, firmware and/or hardware, as is appropriate. In general, the exemplary embodiments of this invention may be implemented by computer software stored in the MEM 10B and executable by the DP 10A of the terminal 10, or by hardware (e.g., ASIC 10E or other firmware circuitry), or by a combination (e.g., FPGA 10E) of software and/or firmware and hardware in the terminal 10.

In general, the various embodiments of the terminal 10 can include, but are not limited to, mobile terminals/stations, cellular telephones, personal digital assistants (PDAs) having wireless communication capabilities, portable computers (e.g., laptops) having wireless communication capabilities, image capture devices such as digital cameras having wireless communication capabilities, gaming devices having wireless communication capabilities, music storage and playback appliances having wireless communication capabilities, as well as portable units or terminals that incorporate combinations of such functions and sensor networks.

The MEM 10B may be of any type suitable to the local technical environment and may be implemented using any suitable data storage technology, such as semiconductor-based memory devices, magnetic memory devices and systems, optical memory devices and systems, fixed memory and removable memory. The DP 10A may be of any type suitable to the local technical environment, and may include one or more of general purpose computers, special purpose computers (e.g., the ASIC/FPGA 10E), microprocessors, digital signal processors (DSPs) and processors based on a multi-core processor architecture, as non-limiting examples.

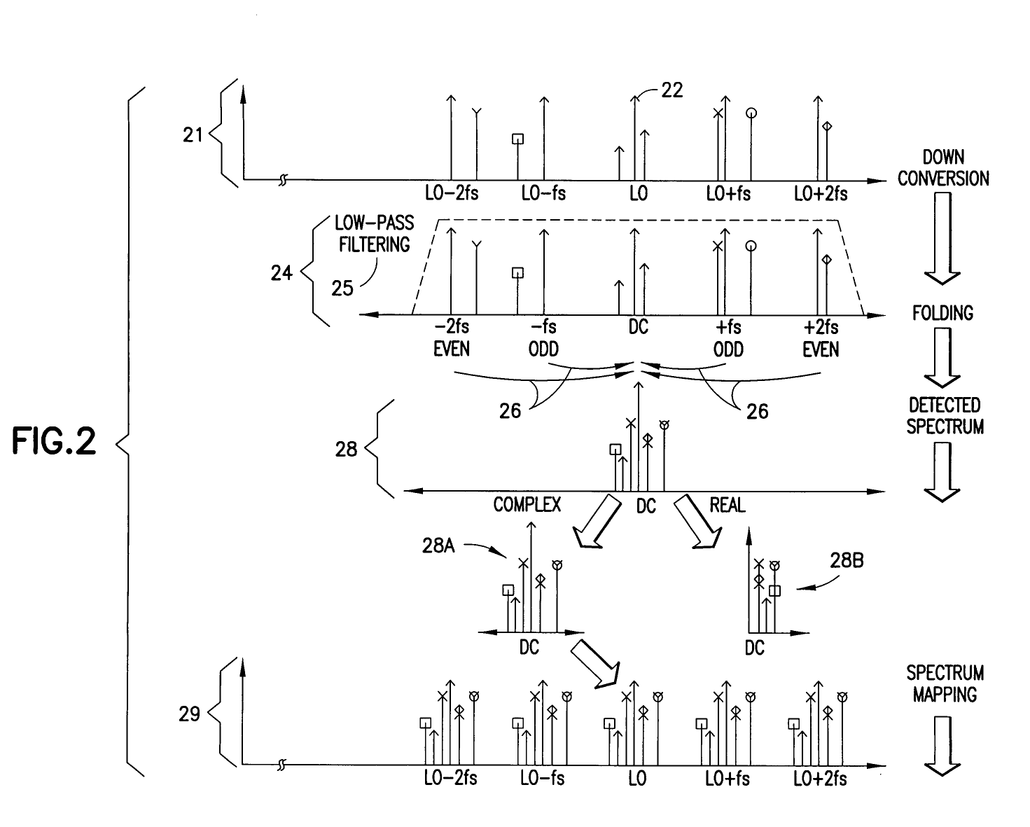

To better understand the embodiments of the invention presented below, the concept of ADC folding is reviewed. When an analog signal, which has high bandwidth, is sampled by a clock signal the spectrum is folded. This happens because the sampled signal can only describe signals that are below the Nyquist frequency (half the sampling frequency, which necessarily depends from the clock signal). Thus, frequencies that are above the Nyquist frequency are folded so that they lie closer to the DC. This concept is shown in FIG. 2, which illustrates the concept of the spectrum folding. The top most row 21 shows the radio frequency (RF) spectrum around the local oscillator (LO) signal 22, which are typically in the gigahertz range. Additionally, FIG. 2 shows in that row 21 four exemplary sampling clock multiples: LO−2fs, LO−fs, LO+fs, and LO+2fs. The next row 24 shows the down-converted complex base band signal spectrum around the DC (aligned with the LO 22) that results when the signal passes through a down-conversion mixer. With the help of a low-pass filter 25 the spectrum is then limited as indicated at the second row 24. Typically the spectrum bandwidth is limited below the Nyquist frequency so that no folding occurs. In the second row 24 of FIG. 2 the spectrum bandwidth is limited above the Nyquist frequency so that folding takes place. The signal is then passed to the ADC where the sampling takes place. When the signal is sampled the signals around the higher sampling frequency multiples fold down toward DC, as indicated by the arrows 26 at the second row 24. The next row 28 shows the folded complex base band spectrum at the output of the ADC.

At this point it is important to differentiate between the complex base band signal 28A and a real base band signal 28B. The complex base band signal 28A has the ability to distinguish between the positive and negative frequencies as shown at FIG. 2 just below the third row 28. To the contrary, the real signal 28B cannot distinguish between the positive and negative frequencies as seen there, and thus the negative signal frequencies are folded (using DC as the pivot point) on top of the positive signal frequencies as is shown at the folded real base band signal 28B where the square identifier for a sample, which was to the left of DC at the complex base band signal 28A, is positioned to the right of DC at the real base band signal 28B to indicate the folding on top. The real or complex spectrum is the end result what the receiver back-end sees. Different techniques to recover the “original” frequencies are described further below.

Apart from these teachings, one would then expect a straightforward spectrum mapping in which the final stage would be to map the detected spectrum back to the original frequency space using the information about the sampling frequency and the LO frequency. The fourth row 29 of FIG. 2 shows the result of the spectrum mapping with the complex base band signal 28A. As can be seen, all the original frequencies are included in the result, but there are also multiple signal frequencies that are falsely detected by the simple spectrum mapping. The square, circle, X or diamond designators are used to distinguish between the different frequencies.

Respecting the wideband analyzer noted above, traditionally a wideband high-speed ADC covered the necessary band. But as above, in the cognitive radio environment this may not be practical in that power consumption increases with bandwidth, and significantly limiting the bandwidth analyzed is not seen to be productive for the end communications in the cognitive radio networks. According to an embodiment of this invention, the wideband analyzer is implemented by folding the spectrum using the folding property of the ADC, which enables a significant reduction in power consumption as the following example illustrates. Consider the case of a 100 MHz ADC. Folding the spectrum twice can cover a bandwidth of 250 MHz, which would traditionally require an ADC clocked at 500 MHz, so the clock speed difference is 5-fold. However, the folding requires two conversions to be made so the actual speed difference is closer to 2.5-fold in this example. It is known that the dynamic power consumption of digital circuitry is directly proportional to the clock rate. That means that for the above example that the folded topology uses 60% less energy than the traditional wideband implementation.

From the folded spectrum the original frequencies must be determined. Several different techniques are presented. In a first technique to determine the original frequencies from the folded spectrum, the wideband and folded ADC are combined. The wideband spectrum is first analyzed with a wideband high speed ADC. Then the same ADC is changed or re-programmed to a folding mode in which its speed is reduced, and therefore its power is also reduced. Equivalently a second ADC may be used instead of re-programming the wideband ADC, but that implementation is seen as less practical for a cognitive radio apparatus and for power savings some reduction would need to be made to the wideband ADC anyway. The information of the wideband spectrum is then combined to the folded spectrum to evaluate the original frequencies of the folded spectrum. This leads to a net reduction in power consumption since the wideband high speed ADC is used only when something changes significantly. This first technique clearly involves either a highly adjustable wideband ADC or two separate ADCs, each of which increases the integrated circuit IC layout area and cost.

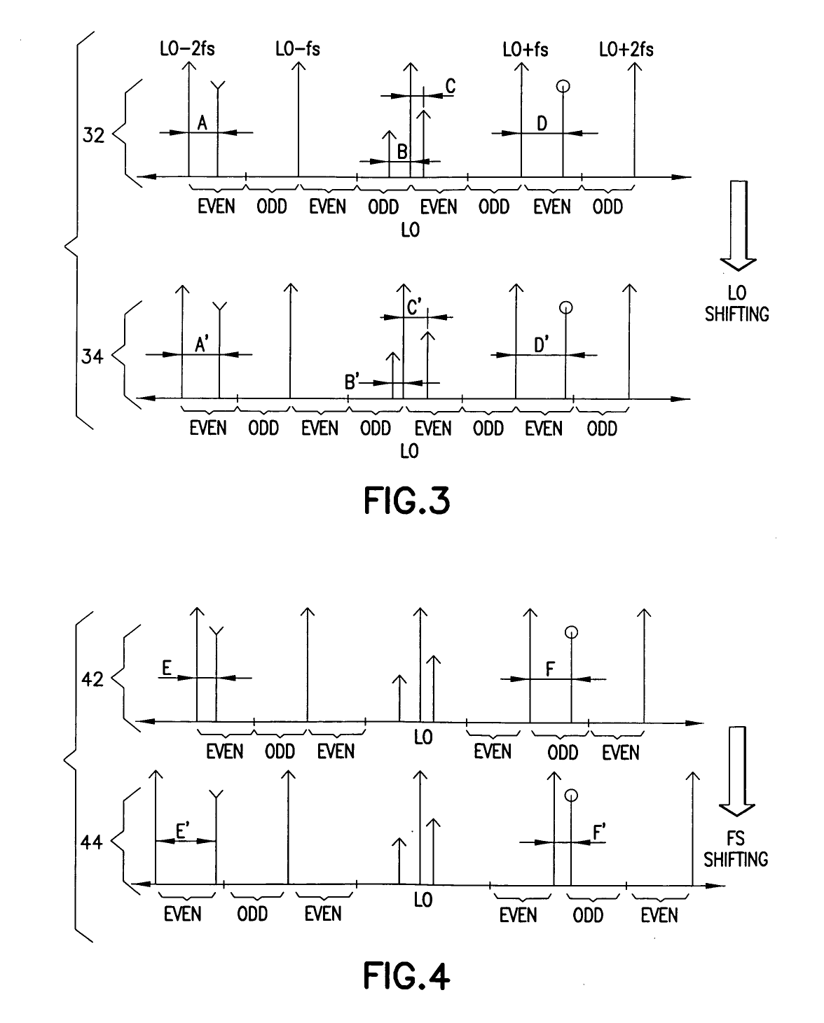

In a second technique to determine the original frequencies from the folded spectrum, a shifted LO signal can be used. If the LO signal is slightly changed (i.e. change the center frequency of the reception band), the signals in the folded spectrum shift differently depending whether they originally belong to an odd or an even folding section. FIG. 3 illustrates odd and even folding sections of equal length/frequency span, one such section each between each adjacent pair of sampling frequency multiples LO−2fs, LO−fs, LO, LO+fs and LO+2fs as shown. The top row 32 has one LO center frequency, and the bottom row 34 has a LO center frequency slightly lower than that of the top row 32. Spectrum sections that lie immediately below a sampling frequency tone (LO or an fs multiple) are labeled as odd and those immediately above a tone are labeled even. If the signal originally is in the even folding section, it moves to a higher frequency as the center frequency LO is changed to a lower frequency as can be seen at the shifts A to A′; C to C′ and D to D′ in FIG. 3. Those signals from the odd sections move to lower frequencies as seen for the shift B to B′ in FIG. 3.

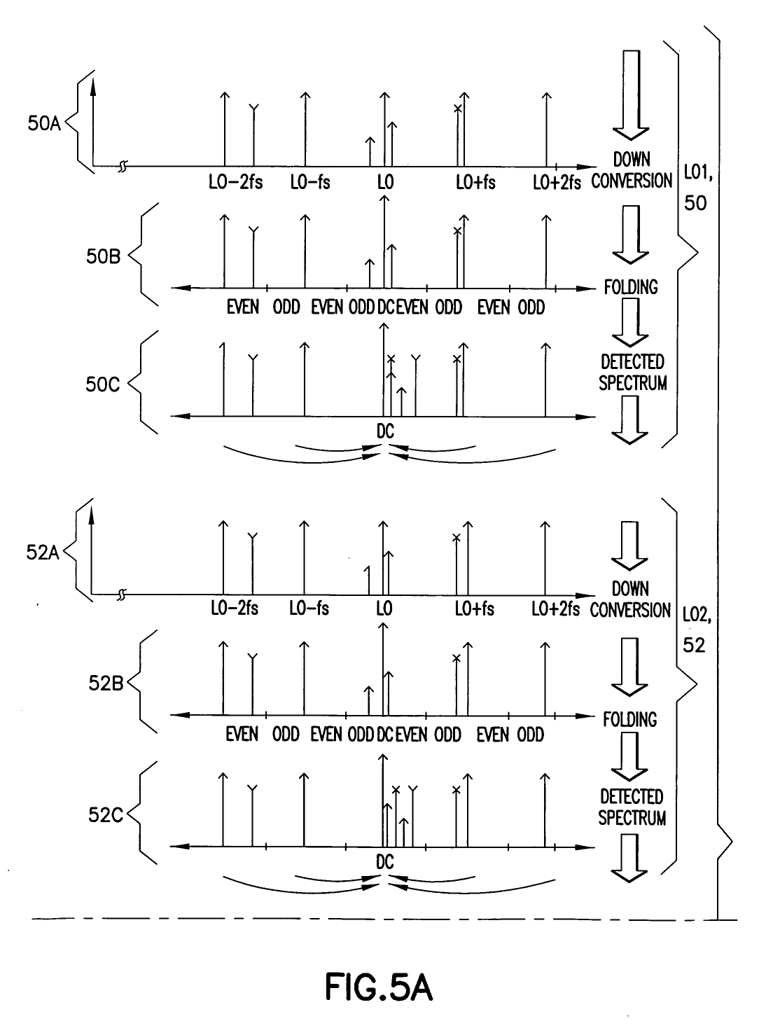

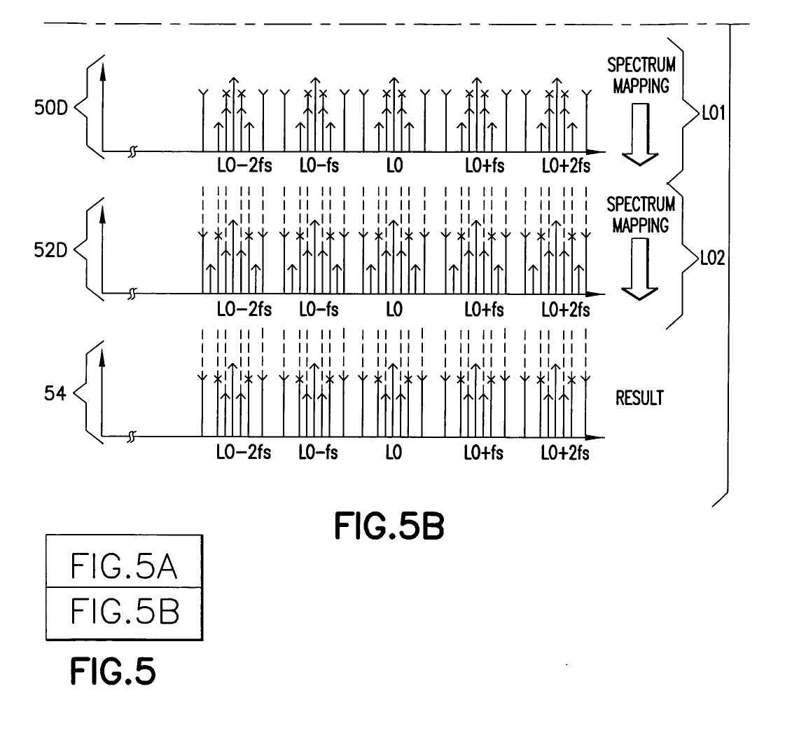

Looking ahead to FIG. 5 the concept of the spectrum estimation with LO shifting is presented. The two top sections 50, 52 illustrate the down-conversion and folding in complex frequency space with two different LO frequencies. Rows of those two sections 50, 52 bearing identical suffixes A, B, C for downconversion, folding and detection (respectively) mirror one another for the shifted frequencies. Row 50D represents spectrum mapping from the LO first frequency sampling at row 50A-C, and row 52D represents spectrum mapping from the LO second (shifted) frequency sampling at row 52A-C. Row 54 then shows the combined result of the mappings at rows 50D and 52D. Valid spectrum values are determined to be such frequencies that appear in both spectrum mappings, which are those shown being connected by dashed lines between rows 50D and 52D. These are the original frequencies. As can be seen from FIG. 5 even a small number of original frequencies results in a very occupied spectrum since the original frequencies are also reproduced to all the images. This method can be used with signals that only have a real part i.e. where only one side of the in-phase/quadrature I-Q signal path is employed. This is due to the fact that I-Q signaling can distinguish between the even and odd sections, so there is no gain in using the LO shifting technique. Additionally, note that this technique can only differentiate between signals in odd and even folding sections. It cannot differentiate between signals in even-even or odd-odd folding sections since they behave identically. Note that in rows 50C and 52C the folded frequency space is real even though the original frequency space is maintained complex to illustrate where the folding signals originate.

In a third technique to determine the original frequencies from the folded spectrum, a shifted sampling frequency FS is used, and this is illustrated at FIG. 4. If the sampling frequency of the folding ADC is changed, it also shifts the locations of the signals in the folded spectrum. Similarly as in the technique above for changing LO, the spectrum components have different directional moves depending on the signals' frequencies. In addition, the shift rate also changes depending on the folding section. When going to a higher folding section (multiple of FS) the signal's movement in the folding spectrum is more rapid, in the folding spectrum, as compared to signals coming from lower frequencies. Row 42 uses a first (shorter) FS and row 44 uses a second (longer) FS. Note that the frequency shift from E to E′, which is in a second-order section LO−2fs, is much more pronounced than the frequency shift from F to F′, which is in a first-order section LO+fs. The rate of frequency shift of a signal in those higher-order sections differs as compared to any other order section, which follows intuitively from the fact that the change to FS compounds with higher order and so extends the difference from LO. Thus, this third technique can also separate from which folding section the frequency is coming from, not just the odd or even folding section as with the LO shift detailed above.

FIG. 4 also shows the even-odd definition for the FS shifting, and it can be seen there that the even and odd frequency sections are symmetric about the LO frequency. When these sections are folded in the ADC, the even sections of row 42 fold on top of the odd sections of row 42 sections and thus we can distinguish between the two. It can also be seen that the even sections of the first row 42 and the second row 44 fold on top of each other. However, this is not a problem since the shift of the frequencies in the second row 44 (with the increased FS) is two times the shift of frequencies in the first row. With quadrature signalling and this third technique of shifting the sampling frequency, the original frequencies can be relatively reliably determined in the vast majority of cases. Similar results can be achieved by using the LO shifting technique above to replace the quadrature signalling, but this is seen to result in three spectrum tests—original, LO shift and FS shift.

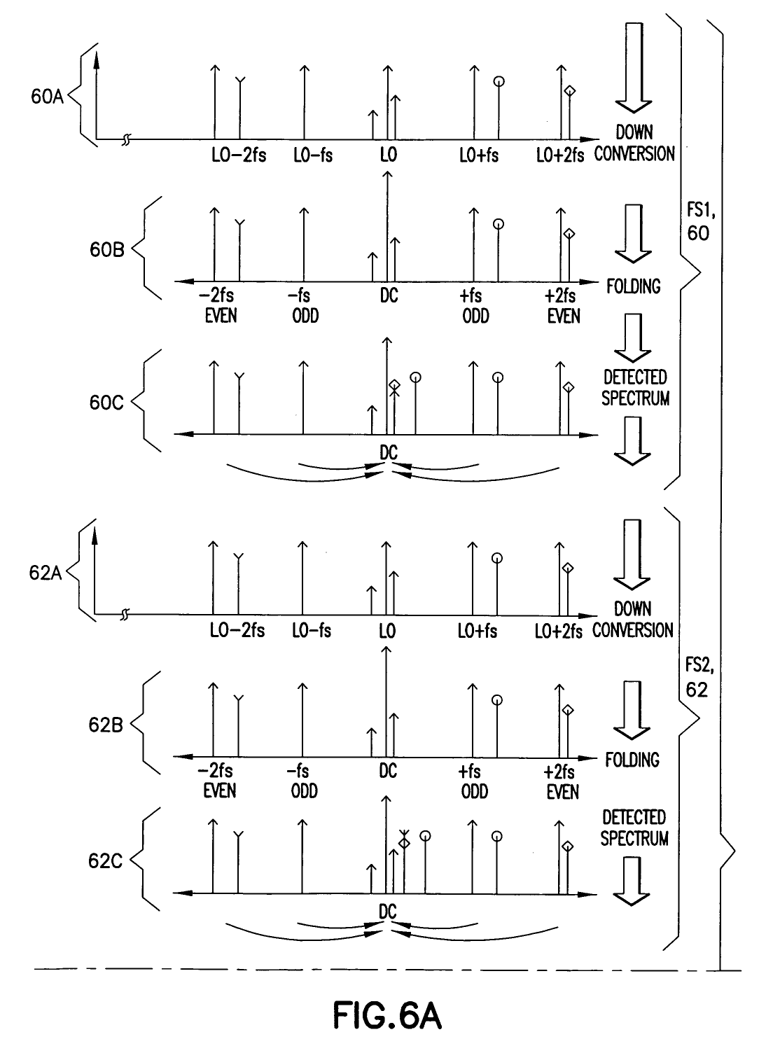

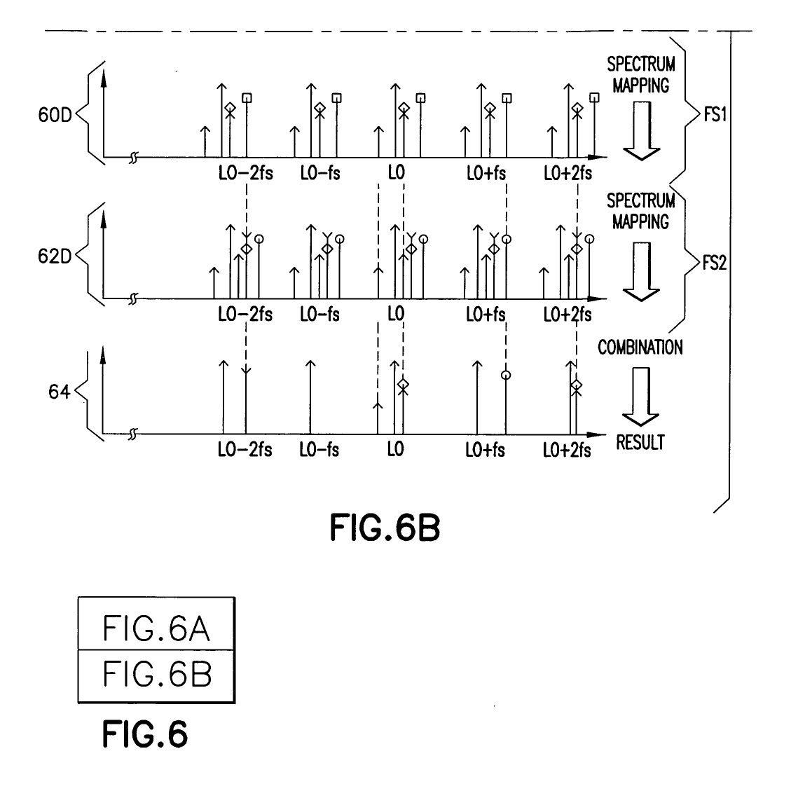

FIG. 6 illustrates an example of the spectrum estimation using the FS shifting technique and quadrature signaling. The top two sections 60, 62 show the spectrum down-conversion 60A, 62A and folding 60B, 62B using two different sampling frequencies. The detected spectrum is shown at rows 60C, 62C. The spectrum mappings 60D, 62D of the two FS cases are also shown and the common frequency points are again highlighted with the dashed lines. The result of those common frequency points is mapped at row 64, which matches the original spectrum.

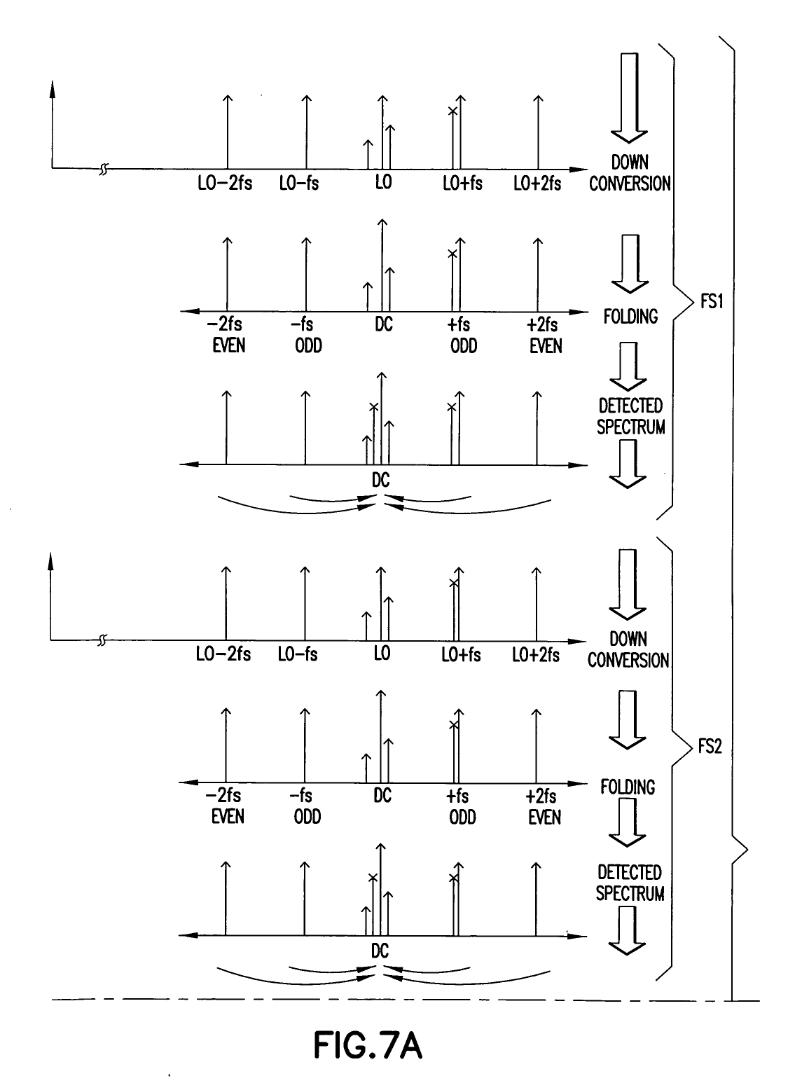

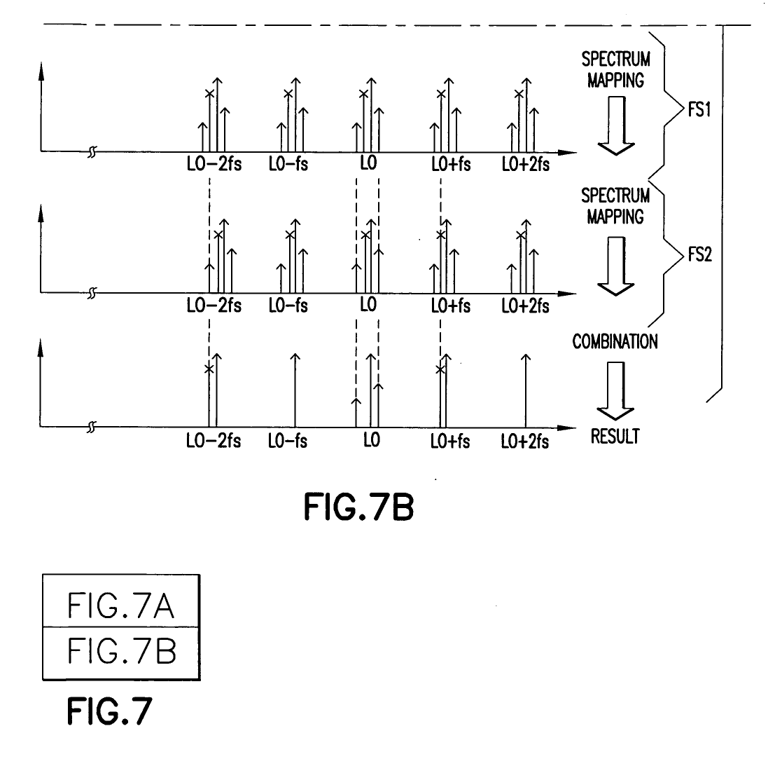

FIG. 7 shows the formation of non-existent frequencies using the sampling frequency shift technique. This is a problem that occurs when the shift of the sampling frequency is equal to the frequency separation of two signals in the folded spectrum. Consider an example. At row 60A we have signals −40, +20 and +80 MHz, with 100 MHz ADC sampling frequency. The signals are folded to −40, −20 and +20 MHz on row 60C. In the second set the input frequencies on row 62A are the same, but sampling frequency has changed to 90 MHz and therefore the folded frequencies are now −40, −10 and +20 MHz. The difference between the sampling frequencies is 10 MHz. When these two results are mapped back around sampling frequency multiples (on rows 60D and 62D), we can calculate the following frequencies (where Fs is 100 MHz):

Negative side:

FIG. 6 row 60D: −40, −20, +20−2Fs; −40, −20, +20−Fs;

FIG. 6 row 62D: −40, −10, +20−2Fs+20; −40, −10, +20−Fs+10;

Positive side:

FIG. 6 row 60D: −40, −20, +20+2Fs; −40, −20, +20+Fs

FIG. 6 row 62D: −40, −10, +20+2Fs−20; −40, −10, +20−Fs−10;

Zero:

FIG. 6 row 60D: −40, −20, +20

FIG. 6 row 62D: −40, −10, +20

Adding the sampling frequency difference results in:

Negative side:

FIG. 6 row 60D: −40, −20, +20−2Fs; −40, −20, +20−Fs;

FIG. 6 row 62D: −20, +10, +50−2Fs; −30, −0, +30−Fs;

Positive side:

FIG. 6 row 60D: −40, −20, +20+2Fs; −40, −20, +20+Fs

FIG. 6 row 62D: −60, −30, +0+2Fs; −50, −20, +10−Fs;

Zero:

FIG. 6 row 60D: −40, −20, +20

FIG. 6 row 62D: −40, −10, +20

Picking out the common frequencies results in row 64 of FIG. 6:

−20−2Fs=−220 MHz

−20+Fs=80 MHz

−40 MHz

+20 MHz

So from this example we can see that the −220 MHz is a falsely detected frequency (see FIG. 7). This result arises from the fact that the frequency difference of the −40 and −20 MHz tones is 20 MHz. When the sampling frequency difference is 10 MHz, this means that with the second folding these two tones will be lined up and detected.

As can be seen from the above, a significant advantage of the embodiments of this invention lies in the use of a folding ADC so as to achieve significant power savings, and in some cases also the implementation of the ADC may become simpler due to the lower sampling frequency. As previously shown, folding the spectrum twice results in approximately 60% power savings. The amount of power saving and reliability of the estimation are inversely proportional to each other.

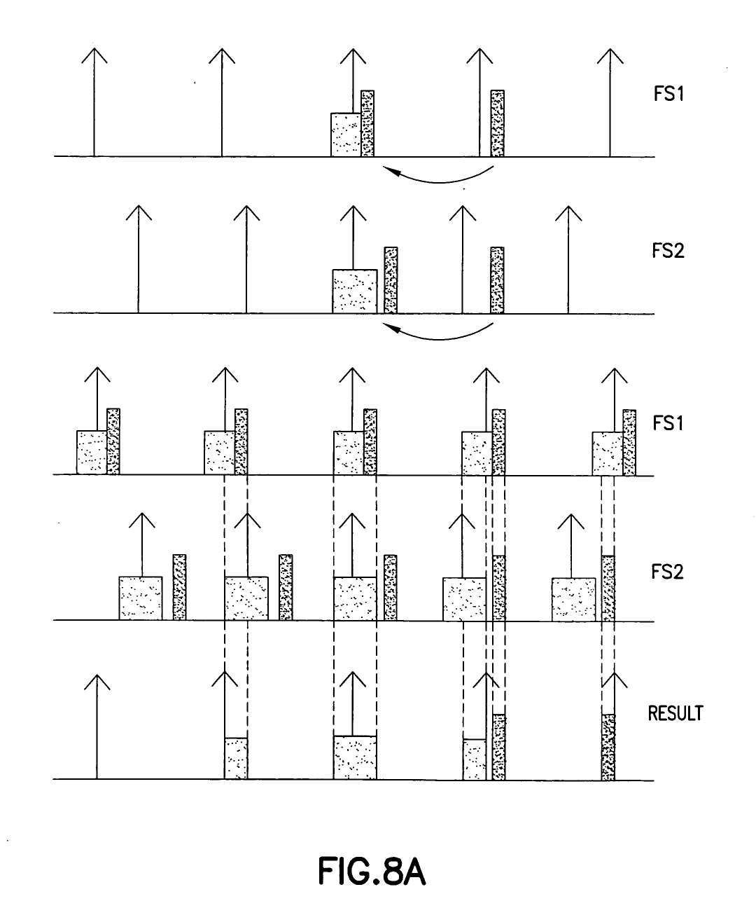

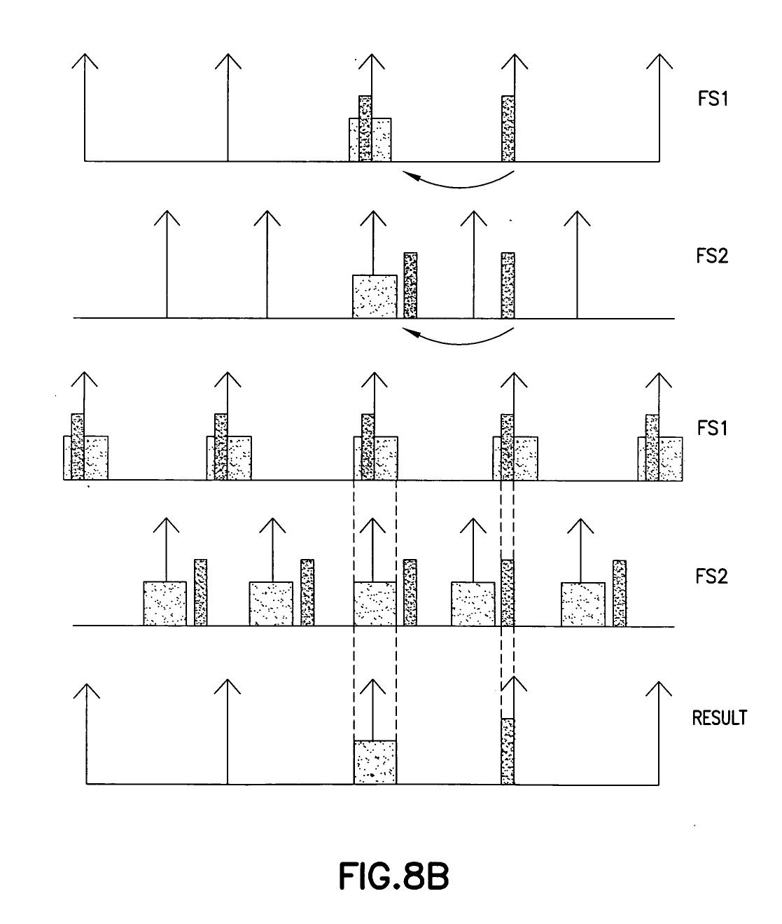

However in the folding, ADC signals from different folding sections are overlapped after the ADC (as previously explained). If the number of input signals is high or if spectrum is folded many times it appears more difficult to differentiate signals from the folding spectrum (i.e. these techniques work best for relatively sparsely occupied spectrum). There exists also a bandwidth problem which concerns the real bandwidths of the expected signals, illustrated at FIG. 8A. If the shift of the LO or FS frequency is not sufficient, it may be that the spectrum estimator cannot detect the change since the signals are still on top of each other. Finally, relating to the bandwidth problem, the bandwidth of the ADC must be several times higher than the highest expected signal bandwidth so that the signal has enough free spectrum to move during the shifting of the LO or sampling frequency.

Consider another example. Assume a first signal 802 with bandwidth of 40 MHz from −20 to +20 MHz as in row 810 of FIG. 8A and another (second) signal 804 from 110 to 120 MHz with 100 MHz sampling frequency. The spectrum is folded so that the second signal lies from +10 to +20 MHz i.e. on top of the first signal as seen at row 812. In order to distinguish between the two signals the sampling frequency has to be changed at least by 10 MHz so that the second signal 804 will not fall on top of the first signal 802, as seen at row 814 where the second signal is designated 804′. The result of this 10 MHz sampling frequency change is shown at row 816 of FIG. 8A. This leads to the rule that in order to overcome the bandwidth problem the shift in sampling frequency must be higher than the highest signal bandwidth present, which is shown at FIG. 8B where the rows designated FS1 would result in the second signal being on top of the first and the rows FS2 depict the proper spacing between them after folding due to a sampling frequency shift as in FIG. 8A.

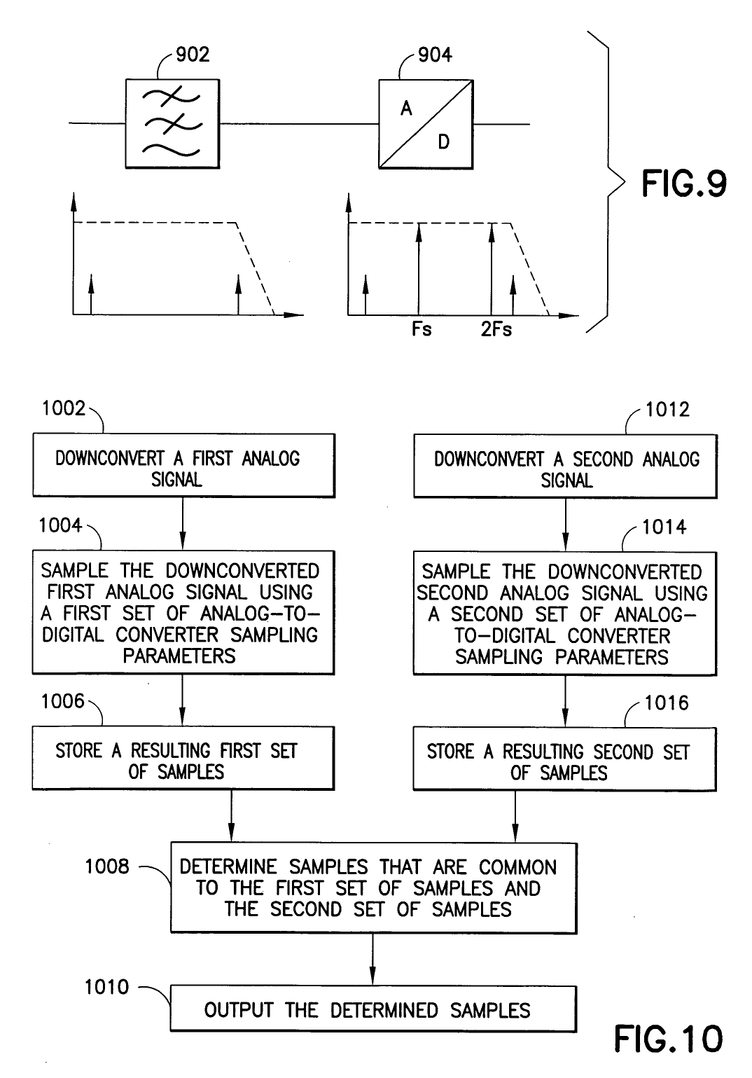

FIG. 9 illustrates particular hardware components that may be used in certain embodiments of the invention. Specifically, that exemplary embodiment includes an ADC 904 and a preceding filter 902 (the antenna 10F would be interfaced to the left of FIG. 9 and further signal processing such as detecting and decoding would interface to the right). The specifics of these two components depends on the estimation technique. If the combined (first) technique is used and only one ADC is used then the ADC bandwidth must be programmable. For the LO shift (second) technique, only conventional ADC is needed, and for sampling frequency shift the ADC clock must be programmable. In addition, the input bandwidth of the ADC should be such that it can handle the whole bandwidth to be folded, e.g. for 100 MHz ADC and two foldings the input bandwidth must be around 250 MHz. For filter implementation the filter must limit the input bandwidth as such required by the ADC.

FIG. 10 is a flow chart from the perspective of a single cognitive radio apparatus that illustrates one possible embodiment of the invention. At block 1002 a first analog signal is downconverted, it is sampled at block 1004 using a first set of ADC sampling parameters and the results are stored at block 1006 as a first set of samples. Similar processing at block s 1012, 1014, and 1016 occur for a second analog signal. At block 1008 from the two stored sample sets are determined samples that are common to both sets, and at block 1010 only those common samples are output for further signal processing such as detecting, decoding, and decrypting elsewhere in the DP 10A or ASIC/FPGA 10E.

In general, the various embodiments may be implemented in hardware or special purpose circuits, software (computer readable instructions embodied on a computer readable medium), logic or any combination thereof. For example, some aspects such as the sequence generator may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation such as FIG. 10, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits ICs is by and large a highly automated process. Complex and powerful software tools are available for converting a logic level design into a semiconductor circuit design ready to be etched and formed on a semiconductor substrate. FIG. 3 may represent specific circuit functions of such an IC.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Although described in the context of particular embodiments, it will be apparent to those skilled in the art that a number of modifications and various changes to these teachings may occur. Thus, while the invention has been particularly shown and described with respect to one or more embodiments thereof, it will be understood by those skilled in the art that certain modifications or changes may be made therein without departing from the scope and spirit of the invention as set forth above, or from the scope of the ensuing claims.

We claim:

1. A method comprising:
downconverting a first analog signal, sampling the downconverted first analog signal using a first set of analog-to-digital converter sampling parameters, and storing a resulting first set of samples;
downconverting a second analog signal, sampling the downconverted second analog signal using a second set of analog-to-digital converter sampling parameters, and storing a resulting second set of samples;
determining samples that are common to the first set of samples and the second set of samples; and
outputting the determined samples.

2. The method of claim 1 wherein the first set of down-conversion mixer parameters differ from the second set of down-conversion mixer parameters at least in local oscillator frequency used for the down-converting.

3. The method of claim 2, wherein the difference in local oscillator frequency is implemented by changing frequency of a local oscillator.

4. The method of claim 2, wherein determining the samples that are common comprises comparing frequency shifts of samples deriving from the first analog signal to frequency shifts of samples deriving from the second analog signal.

5. The method of claim 2, wherein each sampling frequency span is divided into two folding sections and samples that are common are found by comparing samples in corresponding sections.

6. The method of claim 2, wherein the difference in local oscillator frequency used for the downconverting is constrained to be higher than a highest signal bandwidth present for the first or the second analog signal.

7. The method of claim 1 wherein the first set of analog-to-digital converter sampling parameters differ from the second set of analog-to-digital converter sampling parameters at least in sampling frequency.

8. The method of claim 7, wherein the difference in sampling frequency is implemented by changing a sampling rate of an analog-to-digital converter that does the sampling.

9. The method of claim 7, wherein the difference in sampling frequency used for the analog-to-digital converting is constrained to be higher than a highest signal bandwidth present for the first or the second analog signal.

10. The method of claim 1, wherein the first analog signal and the second analog signal each comprise frequencies higher than a Nyquist frequency of an analog-to-digital converter that does the sampling.

11. The method of claim 1, further comprising executing a fast Fourier transform on the samples of the downconverted first analog signal to achieve the resulting first set of samples, and executing a fast Fourier transform on the samples of the downconverted second analog signal to achieve the resulting second set of samples, and where determining samples that are common comprises comparing frequency domain components of the samples.

12. The method of claim 1, executed by a handheld mobile terminal operating in a cognitive radio network.

13. An apparatus comprising:
a local oscillator configured to downconvert a first analog signal and a second analog signal;
an analog to digital converter configured to sample the downconverted first analog signal using a first set of analog-to-digital converter sampling parameters and to sample the downconverted second analog signal using a second set of analog-to-digital converter sampling parameters;
a memory configured to store a first set of samples from the analog to digital converter sampling of the first analog signal and to store a second set of samples from the analog to digital converter sampling of the second analog signal; and
a processor configured to determine samples that are common to the stored first set of samples and the stored second set of samples and to output the determined samples that are common.

14. The apparatus of claim 13, wherein the first set of down-conversion mixer parameters differ from the second set of down-conversion mixer parameters at least in local oscillator frequency used for the down-converting.

15. The apparatus of claim 14, wherein the difference in local oscillator frequency is implemented by changing frequency of the local oscillator.

16. The apparatus of claim 14, wherein the processor is configured to determine the samples that are common by comparing frequency shifts of samples deriving from the first analog signal to frequency shifts of samples deriving from the second analog signal.

17. The apparatus of claim 14, wherein the processor is configured to determine the samples that are common by dividing each sampling frequency span into two folding sections and comparing samples in corresponding sections.

18. The apparatus of claim 14, wherein the difference in local oscillator frequency used for the downconverting is constrained to be higher than a highest signal bandwidth present for the first or the second analog signal

19. The apparatus of claim 13, wherein the first set of analog-to-digital converter sampling parameters differ from the second set of analog-to-digital converter sampling parameters at least in sampling frequency.

20. The apparatus of claim 19, wherein the difference in sampling frequency is implemented by changing a sampling rate of the analog-to-digital converter.

21. The apparatus of claim 13, wherein the first analog signal and the second analog signal each comprise frequencies higher than a Nyquist frequency of the analog-to-digital converter.

22. The apparatus of claim 13, wherein the processor is further configured to execute a fast Fourier transform on the samples of the downconverted first analog signal to achieve the stored first set of samples, and to execute a fast Fourier transform on the samples of the downconverted second analog signal to achieve the stored second set of samples.

23. The apparatus of claim 13, wherein the apparatus comprises a handheld mobile terminal operating in a cognitive radio network.

24. A computer readable memory embodying a program of machine-readable instructions executable by a digital data processor to perform actions directed toward sampling analog signals, the actions comprising:
downconverting a first analog signal, sampling the downconverted first analog signal using a first set of analog-to-digital converter sampling parameters, and storing a resulting first set of samples;
downconverting a second analog signal, sampling the downconverted second analog signal using a second set of analog-to-digital converter sampling parameters, and storing a resulting second set of samples;
determining samples that are common to the first set of samples and the second set of samples; and
outputting the determined samples.

25. The computer readable memory of claim 24, wherein the first set of down-conversion mixer parameters differ from the second set of down-conversion mixer parameters at least in local oscillator frequency used for the down-converting and the difference in local oscillator frequency used for the downconverting is constrained to be higher than a highest signal bandwidth present for the first or the second analog signal.

26. The computer readable memory of claim 24, wherein the first set of analog-to-digital converter sampling parameters differ from the second set of analog-to-digital converter sampling parameters at least in sampling frequency used for the sampling and the difference in sampling frequency used for the sampling is constrained to be higher than a highest signal bandwidth present for the first or the second analog signal.

27. An apparatus comprising:
conversion means for sampling a first analog signal at a first frequency and for sampling a second analog signal at a second frequency;
storage means for storing a first set of samples from the conversion means' sampling of the first analog signal and for storing a second set of samples from the conversion means' sampling of the second analog signal;
decision means for deciding samples that are common to the stored first set of samples and the stored second set of samples and for causing the determined samples that are common to be output for signal processing.
